(19) United States
(12) Patent Application Publication
(10) Pub. No.: US 2008/0166683 A1
(43) Pub. Date: Jul. 10, 2008

(54) Toothbrush

(76) Inventors: Yu-Mei Liao, Kaohsiung (TW); Fan-Hao Chou, Kaohsiung (TW)

Correspondence Address: JACOBSON HOLMAN PLLC, 400 SEVENTH STREET N.W., SUITE 600, WASHINGTON, DC, 20004, US

(21) Appl. No.: 11/651,597

(22) Filed: Jan. 10, 2007

(51) Int. Cl. A61C 17/02; A61C 17/06

(52) U.S. Cl. 433/80; 433/91

(57) ABSTRACT

A toothbrush includes: a hollow head portion defining a first fluid passage therein and having a bristle-mounting wall formed with a plurality of apertures in fluid communication with the first fluid passage; bristles provided on the bristle-mounting wall of the head portion; a hollow grip portion connected to the head portion and defining a second fluid passage therein, the second fluid passage being in fluid communication with the first fluid passage; and a suction unit connected to the grip portion and adapted to draw a fluid from an exterior of the bristle-mounting wall of the hollow head portion through the apertures and the first and second fluid passages.

### BACKGROUND OF THE INVENTION

1. Field of the Invention

This invention relates to a toothbrush, more particularly to a toothbrush including a suction unit which can be used to draw fluids from a user's mouth.

2. Description of the Related Art

A patient, who loses regular oral activity, such as opening/closing of the mouth, swallowing, spitting action, etc., normally needs an assistant to do oral cleaning, e.g., brushing of teeth. Since the patient cannot spit the fluids produced during oral clearing, suffocation is likely to occur. To prevent suffocation, the fluids have to be removed during oral clearing. However, it is relatively difficult and inconvenient for the assistant to remove the fluids from the patient's mouth during brushing of teeth.

Therefore, there is a need in the art to provide a toothbrush that includes a suction unit for drawing the fluids from the patient's mouth during oral clearing, e.g., brushing of teeth.

### SUMMARY OF THE INVENTION

According to this invention, a toothbrush includes a hollow head portion defining a first fluid passage therein and having a bristle-mounting wall formed with a plurality of apertures in fluid communication with the first fluid passage; bristles provided on the bristle-mounting wall of the head portion; a hollow grip portion connected to the head portion and defining a second fluid passage therein, the second fluid passage being in fluid communication with the first fluid passage; and a suction unit connected to the grip portion and adapted to draw a fluid from an exterior of the bristle-mounting wall of the hollow head portion through the apertures and the first and second fluid passages.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary exploded perspective view of the first preferred embodiment of a toothbrush according to this invention;

FIG. 2 is a fragmentary schematic partly sectional view of the first preferred embodiment, illustrating how a suction action through apertures is conducted; and

FIG. 3 is a fragmentary schematic partly sectional view of the second preferred embodiment of the toothbrush according to this invention.

### DETAILED DESCRIPTION OF THE PREFERRED EMBODIMENTS

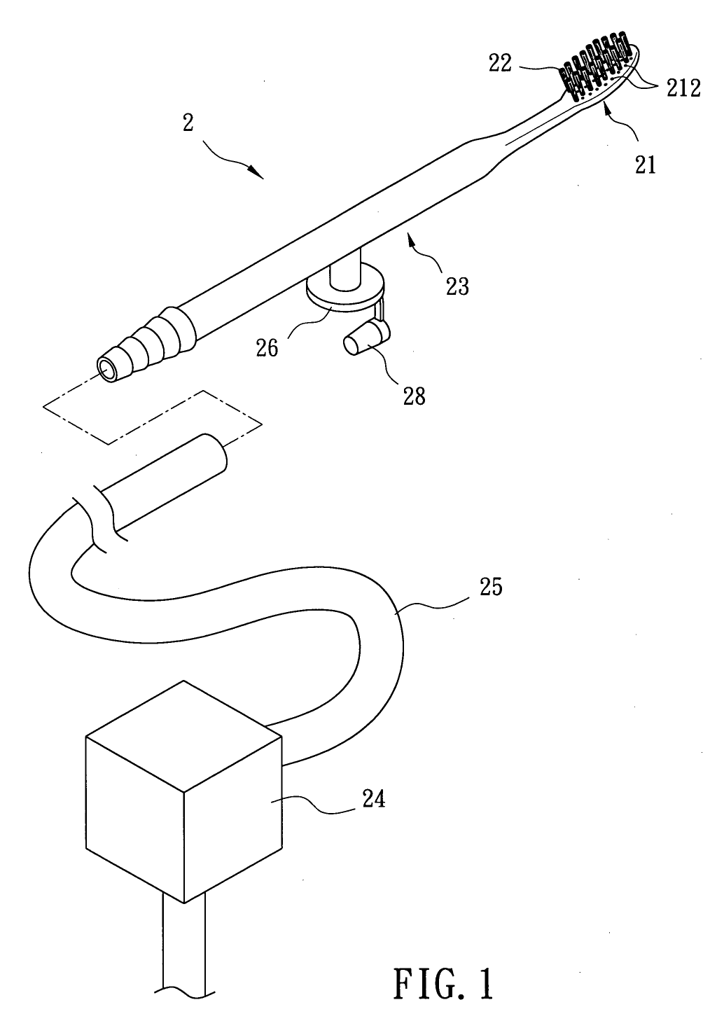

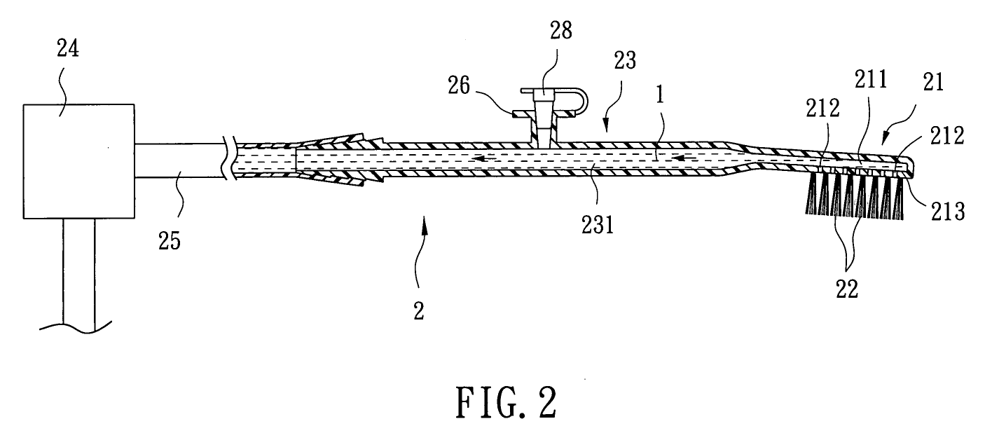

Referring to FIGS. 1 and 2, the first preferred embodiment of a toothbrush 2 according to the present invention is shown to include a hollow head portion 21, bristles 22, a hollow grip portion 23, and a suction unit 24.

The hollow head portion 21 defines a first fluid passage 211 therein and has a bristle-mounting wall 213 formed with a plurality of apertures 212 in fluid communication with the first fluid passage 211. The bristles 22 are provided on the bristle-mounting wall 213 of the hollow head portion 21 and are offset from the apertures 212. The hollow grip portion 23 is connected to the hollow head portion 21 and defines a second fluid passage 231 therein. The second fluid passage 231 is in fluid communication with the first fluid passage 211. The suction unit 24 is connected to the hollow grip portion 23, and is adapted to draw fluids 1 from a user's mouth through the apertures 212 and the first and second fluid passages 211, 231.

Preferably, the hollow grip portion 23 is formed with an air inlet 26 in fluid communication with the second fluid passage 231 and the atmosphere. The toothbrush 2 further includes a cover 28 provided on the grip portion 23 for covering and uncovering the air inlet 26 and for controlling suction action through a selected one of the air inlet 26 and the group of the apertures 212. Specifically, when the fluids 1 are produced during brushing of teeth, the air inlet 26 should be covered by the cover 28 so as to permit withdrawal of the fluids 1 from the user's mouth through the apertures 212. Therefore, the fluids 1 in the mouth can be drawn away through the apertures 212 and the first and second fluid passages 211, 231. When the fluids 1 are substantially removed, the cover 28 covering the air inlet 26 is removed from the air inlet 26 so that the suction action is conducted through the air inlet 26, rather than through the apertures 211.

Preferably, the cover 28 can be a plug, a knob, etc.

Preferably, the toothbrush 2 further includes a tube 25 for interconnecting the hollow grip portion 23 and the suction unit 24. The suction unit 24 can be any kind of pump suitable for achieving the object of this invention.

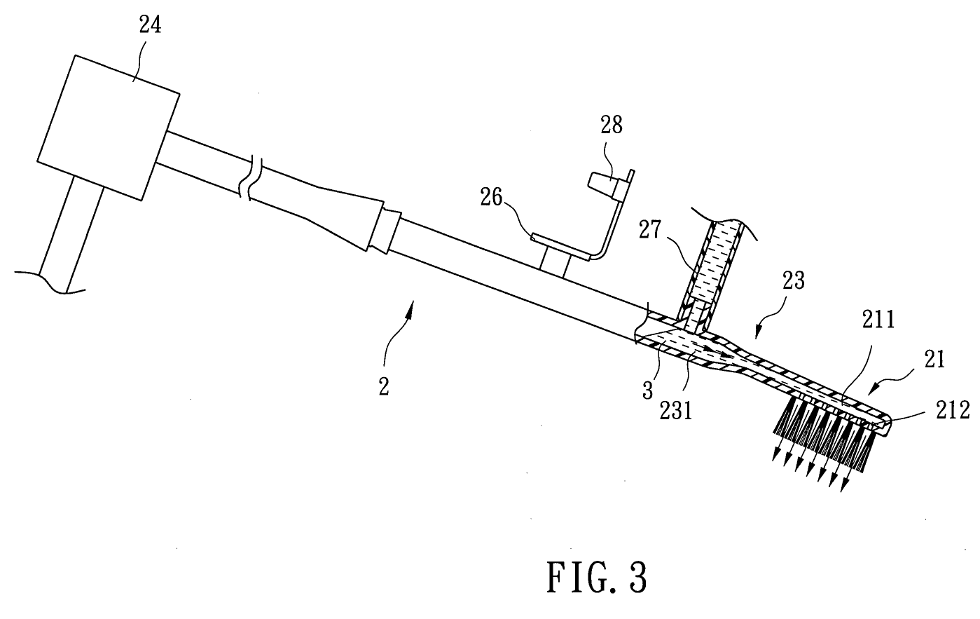

FIG. 3 illustrates the second preferred embodiment of the toothbrush 2 according to this invention. This preferred embodiment differs from the previous embodiment in that the hollow grip portion 23 is further formed with a water inlet 27 disposed at a location between the air inlet 26 and the hollow head portion 21 and in fluid communication with the second fluid passage 231. When a clean fluid 3 is to be injected into the user's mouth through the water inlet 27 for rinsing or cleaning purpose, the air inlet 26 has to be opened so as to prevent the clean fluid 3 from being withdrawn by the suction unit 24. Moreover, the toothbrush 2 has to be disposed at a tilted position, i.e., the hollow grip portion 23 is disposed higher than the hollow head portion 21 so that the clean fluid 3 can flow into the user's mouth from the water inlet 27 through the second fluid passage 231, the first fluid passage 211, and the apertures 212.

With the inclusion of the suction unit 24 in the toothbrush 2 of this invention, brushing of teeth and removal of mouth fluids can be easily and simultaneously carried out by an assistant (i.e., operator) so as to prevent suffocation caused by the fluids produced during brushing of teeth. Moreover, the suction action can be easily controlled by controlling the cover 28 (i.e., through covering and uncovering the air inlet 26).

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A toothbrush comprising:
a hollow head portion defining a first fluid passage therein and having a bristle-mounting wall formed with a plurality of apertures in fluid communication with said first fluid passage;
bristles provided on said bristle-mounting wall of said head portion;
a hollow grip portion connected to said head portion and defining a second fluid passage therein, said second fluid passage being in fluid communication with said first fluid passage; and
a suction unit connected to said grip portion and adapted to draw a fluid from an exterior of said bristle-mounting wall of said hollow head portion through said apertures and said first and second fluid passages.

2. The toothbrush of claim 1, wherein said hollow grip portion is formed with an air inlet in fluid communication with said second fluid passage and the atmosphere, said toothbrush further comprising a cover provided on said grip portion for covering and uncovering said air inlet and for controlling suction action through a selected one of said air inlet and the group of said apertures.

3. The toothbrush of claim 2, wherein said hollow grip portion is formed with a water inlet disposed at a location between said air inlet and said hollow head portion, in fluid communication with said second fluid passage, and adapted to receive water therein.
